(19) United States
(12) Patent Application Publication
(10) Pub. No.: US 2012/0109395 A1
(43) Pub. Date: May 3, 2012

(54) CONTROLLING MULTIPLE SMART APPLIANCES WITH A SINGLE COMMUNICATION INTERFACE

(75) Inventors: Michael Francis Finch, Louisville, KY (US); Jerrod Aaron Kappler, Louisville, KY (US); Steven Keith Root, Buckner, KY (US); Darko Ilickovic, Mount Washington, KY (US); James Steven Downey, Louisville, KY (US); Chad Michael Helms, Louisville, KY (US)

(73) Assignee: General Electric Company

(21) Appl. No.: 12/913,809

(22) Filed: Oct. 28, 2010

(51) Int. Cl. G06F 1/28; H04B 3/36

(52) U.S. Cl. 700/295; 340/425.1

(57) ABSTRACT

A single communication interface for controlling multiple smart appliances. The communication interface can be integral with an appliance and have a port for communicating with at least one other appliance or energy consuming devices. The communication interface can be a separate module connectable to a plurality of appliance or energy consuming devices. A wireless or wired connection can be established between the communication module and an energy management device for controlling the smart appliances or energy consuming devices connected to the communication module. One or more of the appliances or energy consuming devices can be wirelessly connected to the communication interface.

Cross-reference is made to commonly owned, copending U.S. patent application Ser. No. 12/559,636 filed on Sep. 15, 2009, which is hereby incorporated herein by reference in its entirety.

### BACKGROUND

This disclosure relates to energy management, and more particularly to energy management of household consumer appliances. The disclosure finds particular application to changing existing appliances via add-on features or modules, and incorporating new energy saving features and functions into new appliances.

Currently utilities charge a flat rate, but with increasing cost of fuel prices and high energy usage at certain parts of the day, utilities have to buy more energy to supply customers during peak demand. Consequently, utilities are charging higher rates during peak demand. If peak demand can be lowered, then a potential huge cost savings can be achieved and the peak load that the utility has to accommodate is lessened.

One proposed third party solution is to provide a system where a controller “switches” the actual energy supply to the appliance or control unit on and off. However, there is no active control beyond the mere on/off switching.

There are also currently different methods used to determine when variable electricity-pricing schemes go into effect. There are phone lines, schedules, and wireless signals sent by the electrical company. One difficulty is that no peak shaving method for an appliance such as a refrigerator will provide a maximal benefit. Further, different electrical companies use different methods of communicating periods of high electrical demand to their consumers. Other electrical companies simply have rate schedules for different times of day.

Electrical utilities moving to an Advanced Metering Infrastructure (AMI) system will need to communicate to appliances, HVAC, water heaters, etc. in a home or office building. All electrical utility companies (more than 3,000 in the US) will not be using the same communication method to signal in the AMI system. Similarly, known systems do not communicate directly with the appliance using a variety of communication methods and protocols, nor is a modular and standard method created for communication devices to interface and to communicate operational modes to the main controller of the appliance. Although conventional WiFi/ZigBee/PLC communication solutions are becoming commonplace, this disclosure introduces numerous additional lower cost, reliable solutions to trigger “load shedding” responses in appliances or other users of power. This system may also utilize the commonplace solutions as parts of the communication protocols.

### BRIEF DESCRIPTION OF THE DISCLOSURE

The present disclosure reduces power consumption during on-peak hours by reducing the energy demand on the power generation facility, and also enabling the user/consumer to pay less to operate the appliance on an annual basis. This disclosure is a low-cost alternative to using expensive or complicated methods of determining when peak electrical rates apply, and includes a low-cost alternative for connecting multiple energy consuming devices to a energy management controller.

The system provides for appliance sales with a Demand Side Management capable appliance. The Demand Side Management Module (DSMM) is provided to control the energy consumption and control functions of an appliance using a communication method (including but not limited to PLC, FM, AM SSB, WiFi, ZigBee, Radio Broadcast Data System, 802.11, 802.15.4, etc.). The modular approach will enable an appliance to match electrical utility communication requirements. Each electrical utility region may have different communication methods, protocol methods, etc. This modular approach allows an appliance to be adapted to a particular geographical area of a consumer or a particular electrical provider. The module can be added as a follow on feature and applied after the appliance is installed. Typical installations could include an integral mounted module (inside the appliance or unit) or an externally mounted module (at the wall electrical receptacle or anywhere outside the appliance or unit). The module in this disclosure provides for 2 way communications if needed, and will provide for several states of operation—for example, 1) normal operation, 2) open in low energy mode (but not off), and 3) operation in lowest energy mode.

This module could be powered from the appliance or via a separate power supply, or with rechargeable batteries. The rechargeable batteries could be set to charge under off-peak conditions. With the module powered from the appliance, the appliance could turn it off until the appliance needed to make a decision about power usage, eliminating the standby power draw of the module. If powered separately, the appliance could go to a low energy state or completely off, while the module continued to monitor rates.

In one exemplary embodiment, a household appliance system includes an appliance control system having a common appliance interface provided on an appliance and a demand side management module connected to the appliance interface. The module corresponds to one select utility of a plurality of utilities and is adapted to communicate with the one select utility of the plurality of utilities. The appliance control system operates the appliance based on communications with the one select utility through the module.

In another exemplary embodiment, a method is provided for configuring an appliance to communicate with one select utility of a plurality of utilities. In the method, a module is selected from a plurality of modules corresponding to one select utility of a plurality of utilities. The selected module is deployed in an appliance. The appliance then communicates with the one select utility through the module and is operated based on the communication with the one select utility.

In a further exemplary embodiment, a method is provided for configuring appliances to communicate with utilities. In the method, a first set of modules is provided corresponding to a first utility and a second set of modules is provided corresponding to a second utility. The first set of modules is deployed in a first set of appliances for communicating with the first utility. The second set of modules is deployed in a second set of appliances for communicating with the second utility.

Use of RFID tags in one proposed system should offer significant savings since RFID tags have become very low cost due to the proliferation of these devices in retail and will effectively allow the enabled appliance to effectively communicate with the utility meter (e.g., receive signals from the utility meter). This system makes it very easy for a customer to manage energy usage during peak demand periods and lowers the inconvenience level to the customer by not shutting off appliances in the home by the utility. When local storage and local generation are integrated into the system, then cost savings are seen by the customer. This system also solves the issue of rolling brownouts/blackouts caused by excessive power demand by lowering the overall demand. Also, the system allows the customer to pre-program choices into the system that will ultimately lower utility demand as well as save the customer money in the customer's utility billing. For instance, the customer may choose to disable the defrost cycle of a refrigerator during peak rate timeframes. This disclosure provides for the controller to “communicate” with the internal appliance control board and command the appliance to execute specific actions with no curtailment in the energy supply. This disclosure further provides a method of communicating data between a master device and one or more slave devices using RFID technology. This can be a number of states or signals, either using one or more passive RFID tags that resonate at different frequencies resonated by the master, or one or more active RFID tags that can store data that can be manipulated by the master device and read by the slave device(s). The states in either the passive or active RFID tags can then be read by the microcontroller on the slave device(s) and appropriate functions/actions can be taken based upon these signals.

One advantage of this approach is that customers have complete control of their power. There have been proposals by utilities to shut off customers if they exceed demand limits or increase the number of rolling brownouts. This method also gives a customer finer granulity in their home in terms of control. A customer does not have to load shed a room just to manage a single device.

This disclosure also advantageously provides modes of load shedding in the appliance, lighting, or HVAC other than “on/off” to make the situation more acceptable from the perspective of the customer.

An advantage of the present disclosure is the ability to produce appliances with a common interface and let the module deal with the Demand Side Management.

Another advantage is the ability to control functions and features within the appliance and/or unit at various energy levels, as opposed to just an on/off function.

Another advantage is that the consumer can choose the module or choose not to have the module. If the module is chosen, it can be matched to the particular electrical utility service provider communication method of the consumer.

Another benefit is the increased flexibility with an associated electrical service provider, and the provision of several modes of operation (not simply an on/off mode). The module can be placed or positioned inside or outside the appliance and/or unit to provide demand side management.

Still other benefits relate to modularity, the ability to handle multiple communication methods and protocols without adversely impacting the cost of the appliance, opening up appliances to a variety of protocols, enabling demand side management or energy management, and/or providing for a standard interface to the appliance (for example, offering prechill and/or temperature set change during on-peak hours).

Low cost, reliable RF transmissions within the home, rather than using industrial solutions such as PLC or Zigbee solutions which are significantly more costly than the aforementioned system, are yet another benefit.

In accordance with another aspect, an appliance comprises an energy consuming device, and a communication interface for sending/receiving communications between the appliance and a remote energy management device, the communications including at least one of commands for controlling the energy consuming device and data relating to the usage of the energy consuming device. The communication interface further includes a communication port for communicating with a second appliance, the communication interface adapted to relay communications between the second appliance and the remote energy management device. The communication port can be a wired port adapted to receive a cable from the at least one other appliance for communication therewith. The wired port can include at least one of an Ethernet port, a serial port, RS-232 serial port, I2C, RS-485, and Firewire. The communication port can be a wireless port adapted to communicate wirelessly with the at least one other appliance, such as via short-range wireless communication protocol including Bluetooth, Wifi, RFID, Zigbee radio, and 802.15.4 radio.

In one example, the appliance and the at least one other appliance are a pair of appliances commonly associated with each other and in close proximity such as a washer/dryer set, a microwave oven and a cooking range, an HVAC unit and a water heater. The appliance can be configured to utilize data received from the at least one other appliance for controlling at least one aspect of its operation.

In accordance with another aspect, a device for connecting a plurality of energy consuming devices to a home energy management network comprises a first communication port for communicating with a first energy consuming device, a second communication port for communicating with a second energy consuming device, and a communication interface for communicating with a remote device, the communication interface adapted to connect the first and second communication ports to the remote device for communication therewith. The communications can include at least one of commands for controlling the energy consuming devices and data relating to the usage of the energy consuming devices. At least one of the first and second communication ports can be a wireless communication port. The wireless communication port can be adapted to communicate via at least one short-range wireless communication protocol including Bluetooth, Wifi, RFID, Zigbee radio, and 802.15.4 radio. The communication interface can be a wireless communication interface, and can be in the form of a Y-connector cable having first and second ends for connecting to the first and second energy consuming devices, and a third end connected to the communication interface including an RF radio, wherein the communication interfaces is adapted to communicate with the first and second energy consuming devices when connected thereto via the Y-connector. In one example, the appliance is the first energy consuming device and the first communication port communicates with the appliance, and the second communication port is adapted to communicate with a second appliance.

A system of appliances for use in a home energy management network is also provided comprising a first appliance having an energy consuming device, a second appliance having an energy consuming device, and the device for connecting a plurality of energy consuming devices to a home energy management network connected to the first and second appliances via its first and second communication ports. The device for connecting a plurality of energy consuming devices to a home energy management unit can be integrated with one of the first or second appliances. The first and second appliances can be a pair of appliances commonly associated with each other and in close proximity including a washer/dryer set, a microwave oven and a cooking range, an HVAC unit and a water heater. The first appliance can be configured to utilize data received from the second appliance for controlling at least one aspect of its operation.

In accordance with another aspect, a method of connecting a plurality of energy consuming devices to a home energy management network comprises connecting a first energy consuming device to a second energy consuming device, communicating data relating to the usage of the second energy consuming device to the first energy consuming device, and communicating data via a communication interface of the first energy consuming device relating to the usage of both the first and second energy consuming devices. The first energy consuming device is associated with a first appliance and the second energy consuming device is associated with a second appliance. The method can further comprise controlling at least one aspect of operation of the first energy consuming device in response to data received from the second energy consuming device.

Still other features and benefits of the present disclosure will become apparent from reading and understanding the following detailed description.

### BRIEF DESCRIPTION OF THE DRAWINGS

FIGS. 1-21 illustrate various systems and methods in accordance with the exemplary embodiments described herein.

FIG. 22 is a schematic view of a household appliance system including an appliance control system having a common appliance interface provided on an appliance in the demand side module connected to the common appliance interface.

FIG. 23 a schematic view of an appliance having an integral demand side management module configured for two-way communications with an advanced metering infrastructure (AMI) device connected to a utility.

FIG. 24 is a schematic view of an appliance having a demand side management module configured to receive one-way communications from a utility.

FIG. 25 is a process diagram illustrating a method for configuring an appliance to communicate with one select utility of a plurality of utilities.

FIG. 26 is process flow diagram illustrating further steps for the method of FIG. 25.

FIG. 27 is a process flow diagram lustrating a method for configuring appliances to communicate with utilities.

FIG. 28 is a schematic diagram of a demand side module communicating with an advanced metering infrastructure (AMI) system.

FIG. 29 is a schematic diagram of a pair of appliances sharing a common communication interface connected to each of the appliances.

FIG. 30 is a schematic diagram of a pair of appliances sharing a communication interface located within one of the appliances.

FIG. 31 is a schematic diagram of an exemplary communication module that can be associated with a pair of appliances.

### DETAILED DESCRIPTION OF THE PREFERRED EMBODIMENTS

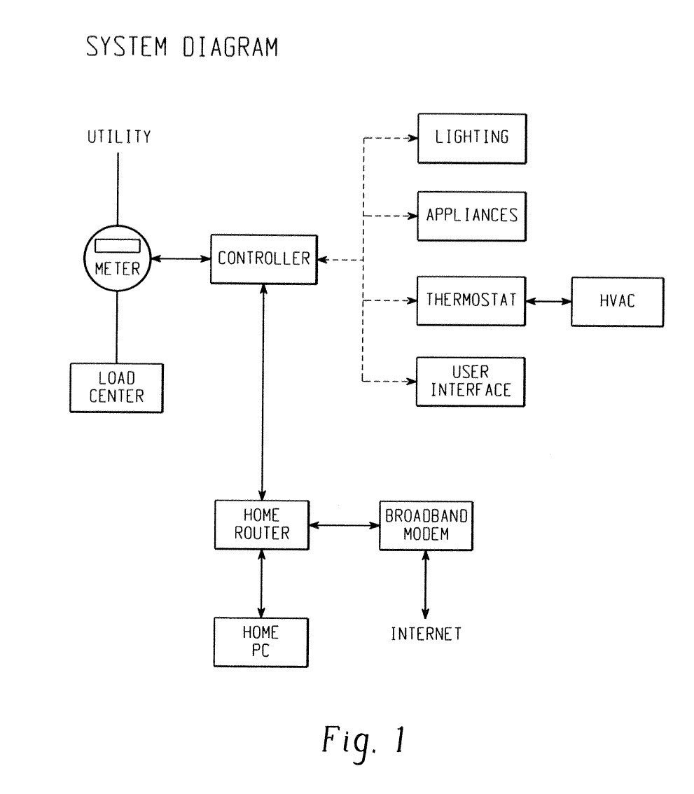

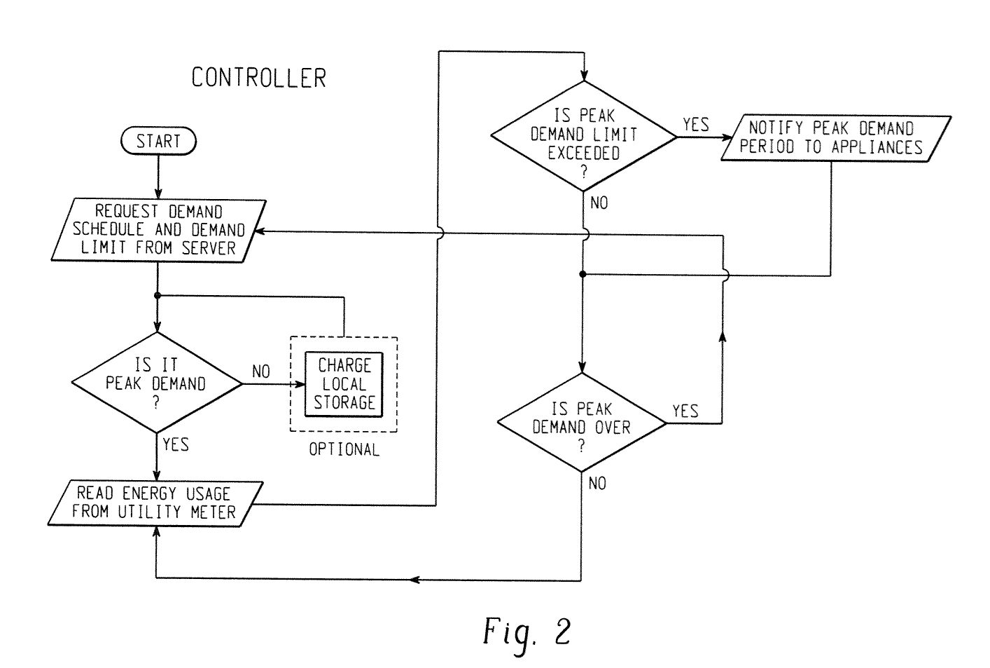

In one embodiment, a more advanced system is provided to handle energy management between the utility and the homeowner's appliances. The system can include one or more of the following: a controller, utility meter, communication network, intelligent appliances, local storage, local generator and/or demand server. Less advanced systems may actually allow the appliance to “communicate directly with the utility meter or mesh network through the DSMM (Demand Side Management Module) (FIG. 1). The demand server is a computer system that notifies the controller when the utility is in peak demand and what is the utility's current demand limit. A utility meter can also provide the controller the occurrence of peak demand and demand limit. The demand limit can also be set by the home owner. Additionally, the homeowner can choose to force various modes in the appliance control based on the rate the utility is charging at different times of the day. The controller will look at the energy consumption currently used by the home via the utility meter and see if the home is exceeding the demand limit read from the server. If the demand limit is exceeded, the controller will notify the intelligent appliances, lighting and thermostat/HVAC (FIG. 2).

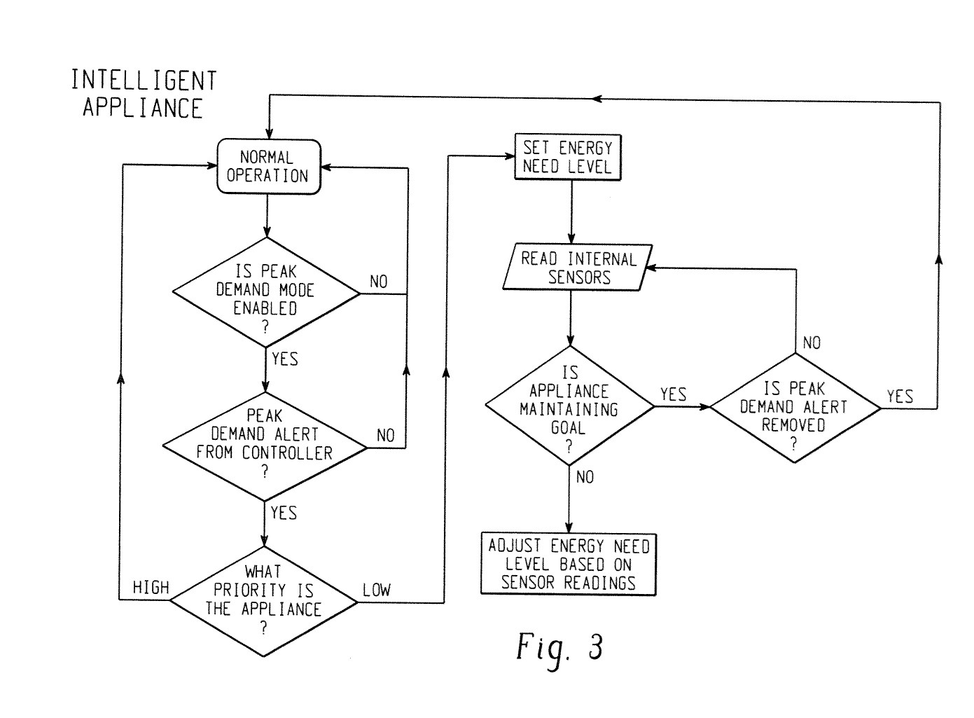

Each intelligent appliance has a communication interface that links itself to a home energy management device having the controller (FIG. 3). This interface can be power-line carrier, wireless, and/or wired. The controller will interact with the appliance and lighting controls as well as thermostat (for HVAC) to execute the users preferences/settings. As will be described in more detail below, some appliances that are in close proximity may share a common communication interface. For example, a washer and dryer set may be connected to a common communication interface, or the dryer may be connected to the washer and use the washer's communication interface to link to the controller.

Enabled appliances receive signals from the utility meter and help lower the peak load on the utility and lower the amount of energy that the consumer uses during high energy cost periods of the day. There are several ways to accomplish this, through wireless communication (ZigBee, WiFi, etc) or through PLC (power line carrier) communication. Alternatively, using passive RFID tags that resonate at different frequencies resonated by the master, or one or more active RFID tags that can store data that can be manipulated by the master device and read by the slave devices(s) is an effective and potentially lower cost communication solution since there is no protocol. Rather, a pulse of energy at a particular frequency will allow a low cost method with an open protocol for transmitting/communicating between a master device and one or more slave devices, and appropriate functions/actions can be taken based upon these signals.

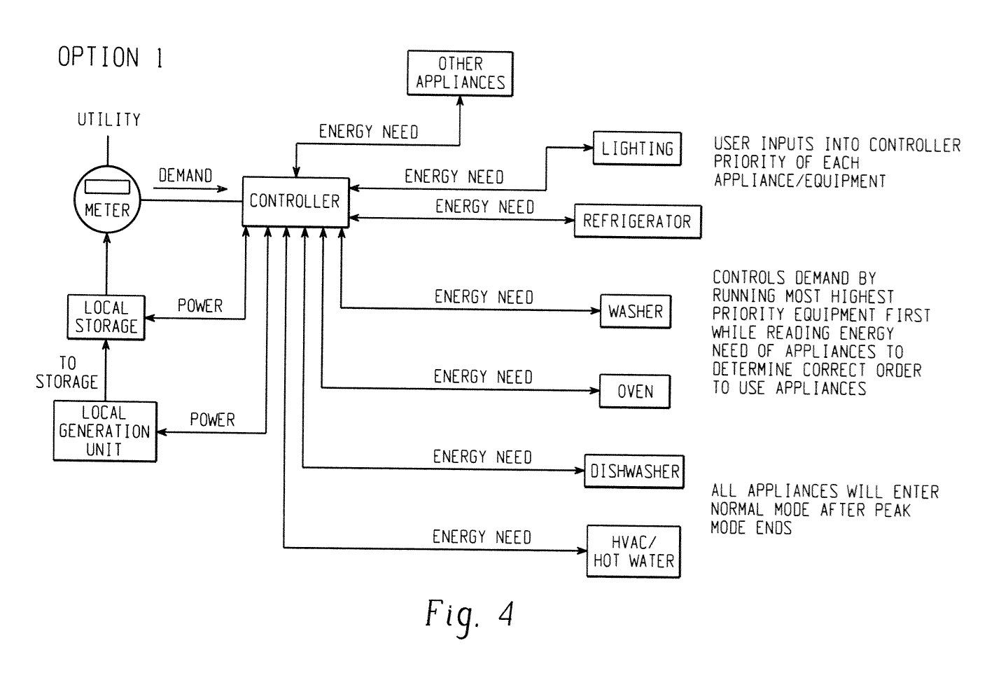

The interaction between controller and appliances can occur in two ways. For example, in one scenario during a peak demand period, the controller will receive a demand limit from the utility, demand server or user. The controller will then allocate the home's demand based on two factors: priority of the appliance and energy need level (FIG. 4). The priority dictates which appliances have higher priority to be in full or partial energy mode than other appliances. Energy need dictates how much energy is required for a certain time period in order for that appliance to function properly. If the appliance's energy need is too low to function properly, the appliance moves to a normal mode or a higher energy need level. The energy saving mode is typically a lower energy usage mode for the appliance such as shutdowns of compressors and motors, delayed cycles, higher operating temperatures in summer or lower operating temperatures in winter until the peak demand period is over. Once the demand limit is reached, the appliances will stay in their energy mode until peak demand is over, or a user overrides, or appliance finishes need cycle or priority changes. The controller constantly receives status updates from the appliances in order to determine which state they are in and in order to determine if priorities need to change to accomplish the system goals.

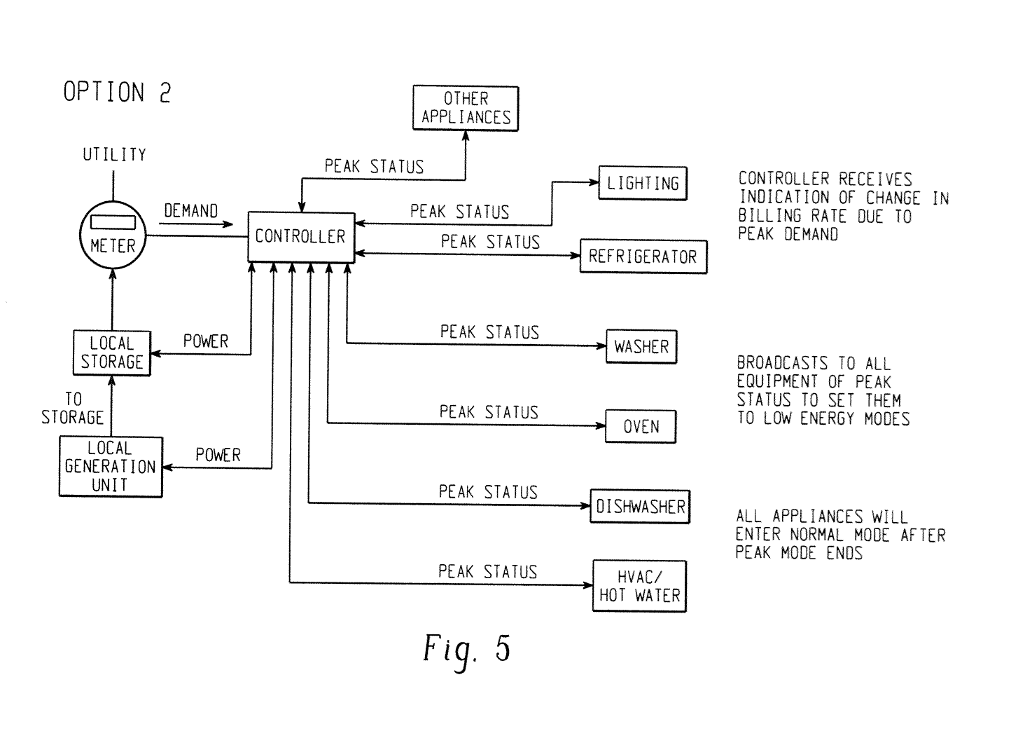

In a second scenario, for example, a set point is provided. During a peak demand period, the controller will tell each appliance to go into peak demand mode (FIG. 5). The appliance will then go into a lower energy mode. The customer can deactivate the energy savings mode by selecting a feature on the appliance front end controls (i.e. user interface board) before or during the appliance use or at the controller. The controller can also communicate to a local storage or power generation unit. This local unit is connected to the incoming power supply from the utility. The controller notifies the storage unit to charge when it is not in peak demand, if a storage unit is included and available. If the storage unit has enough energy to supply the appliances during peak demand, then the controller will switch the home's energy consumption from the utility to the storage unit. The unit can also be local generator/storage such as solar, hydrogen fuel cell, etc.

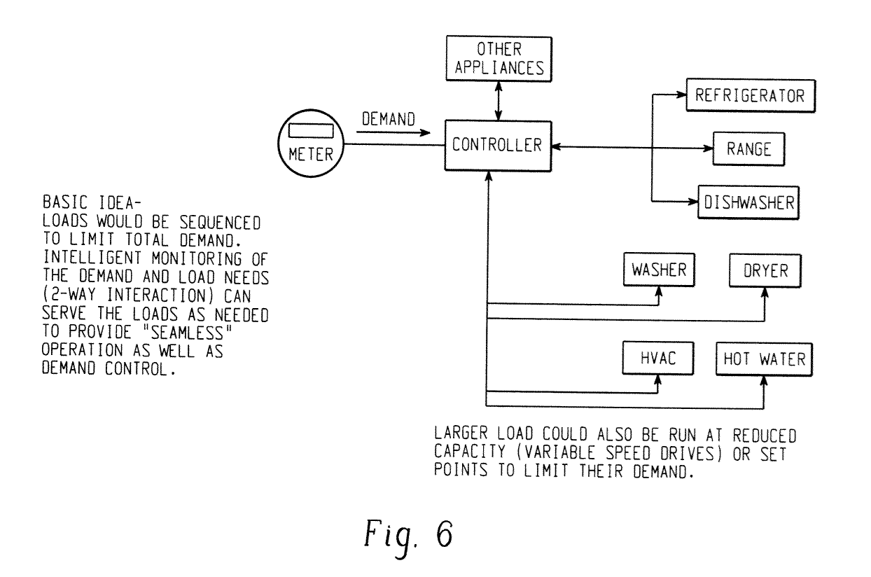

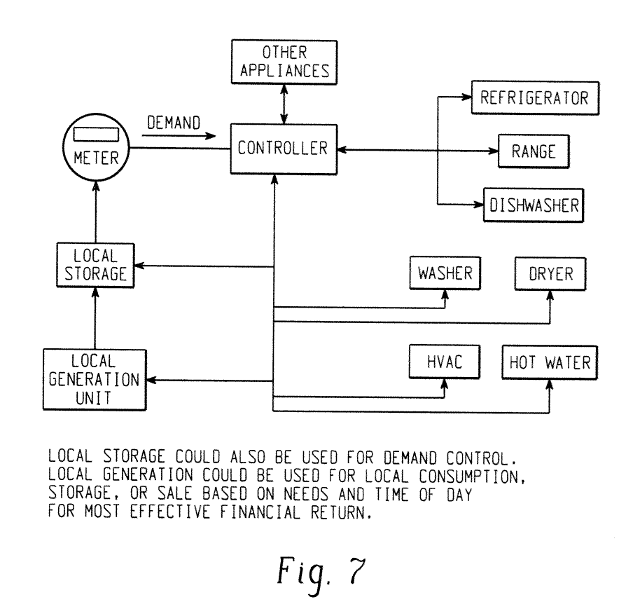

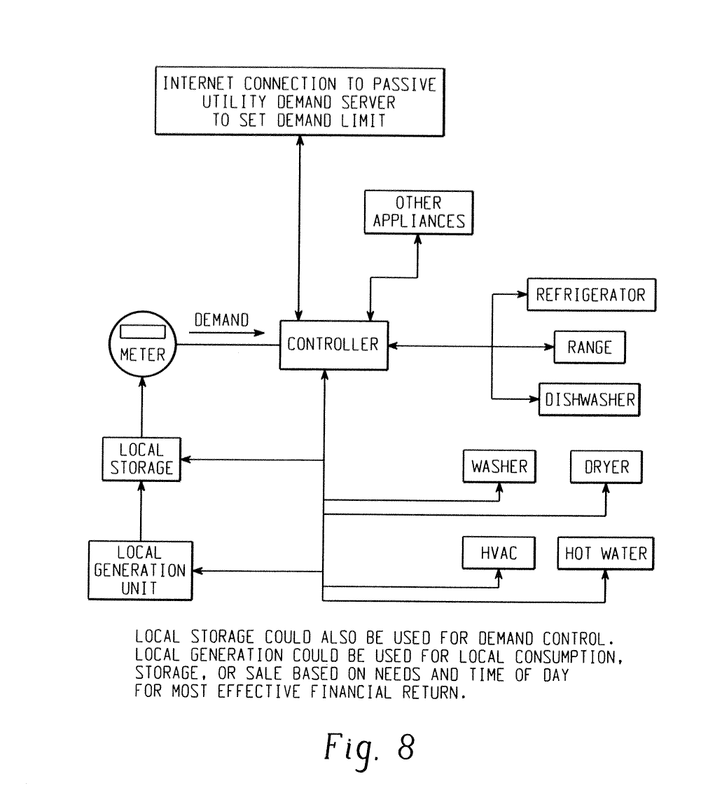

The central controller handles energy management between the utility and home appliances, lighting, thermostat/HVAC, etc. with customer choices incorporated in the decision making process. The controller may include notification of an energy saving mode based on demand limit read from one or more of a utility meter, utility, demand server or user. An energy savings mode of an appliance can thereby be controlled or regulated based on priority and energy need level sent from the controller and/or the customer (FIG. 6). Likewise, consideration to use of local energy storage and use of a local generator to offset peak demand limit can be incorporated into the energy management considerations, or provide the ability to override mode of energy savings through the controller or at the appliance, lighting, or thermostat/HVAC (FIGS. 7 and 8).

The present disclosure has the ability for the home to shed loads in pending brown-out or black-out situations, yet have intelligence to prevent an improper action such as shutting down the refrigerator for extended timeframes that might compromise food storage safety.

How much energy the appliance consumes in peak demand is based on priority of the device and the energy need level. If the appliance's priority is high, then the appliance will most likely not go into a saving mode. The energy need level is based on how little energy the appliance can consume during peak demand and still provide the function setting it is in (i.e. in a refrigerator, ensuring that the temperature is cool enough to prevent spoiling). It will also be appreciated that an appliance may have multiple energy need levels.

The controller will be the main product with the communication and settings control incorporated within future appliances. Specific meters will be selected so that the controller can read the demand usage. It is intended that the demand server will possibly be purchased or leased to the utility.

A method is provided for constructing an appliance designed to perform any key function, the appliance comprises of several mechanical and electrical elements controlled by a main controller. This main controller has a port for receiving information regarding the operational state of the appliance. The port also has a user interface or switch which could be used to override the information received by the controller through the port. Two-way or one-way communication devices may be connected to the port. These communication devices will receive signals from a remote controller, process those signals and as a result communicate an operational state to the main controller of the appliance. This operational state is communicated to the main controller by one or more remote controllers in a specific format determined by the appliance. These signals from the remote controller(s) could be based on a variety of communication methods and associated protocols. On receiving the operational state signal, the appliance main controller causes the appliance to run a predetermined operational mode. These operational modes are designed into the appliance(s) and result in different resource consumption levels or patterns, even delaying use. Resources could include energy, water, air, heat, sunlight, time, etc. In future appliance models, the consumer might be given the authority to modify the appliance responses to a given rate signal. The consumer would be presented a “check box” of potential response modes and allowed to choose within set parameters. For instance, the consumer might be allowed to choose the amount of temperature adjustment a refrigerator will make in response to a high utility rate.

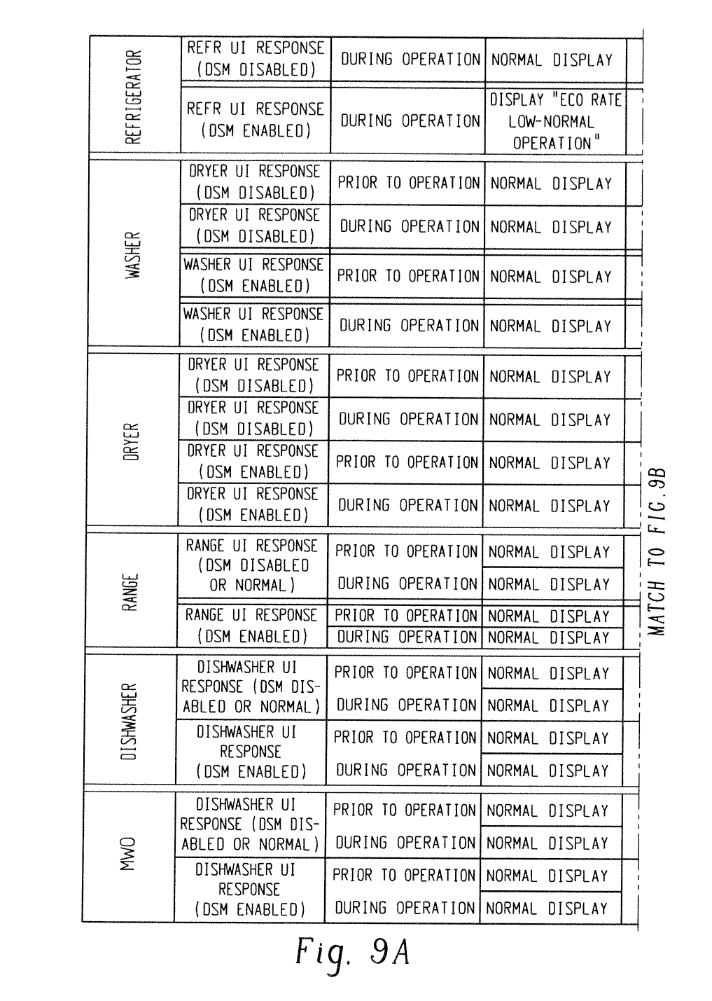

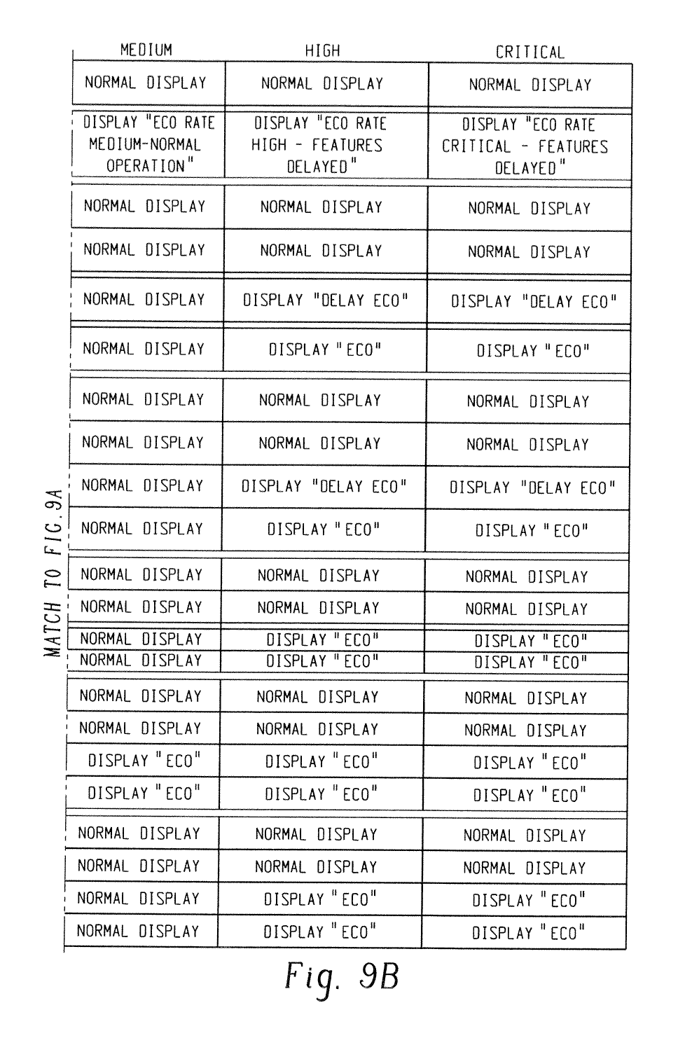

Thus, by way of example only, the structure and/or operation of a refrigerator (FIG. 9, although other appliances are also represented) may be modified or altered by reducing the temperature, especially in the freezer compartment pre on-peak time and further temporarily provide a compartment temperature increase to shave on-peak load. Specifically, defrost operation could be delayed until off-peak time. Alternatively or conjunctively, the freezer and refrigerator temperature setpoints may be set to maintain less compressor on time during on-peak demand times. Similarly, the refrigerator/freezer could be programmed so that lights will not be permitted to come on or the lights must be dimmed lights during on-peak demand times. During on-peak demand times, the fan operating speeds can be reduced, and/or compressor operating speed reduced in order to reduce energy consumption. Still another option is to reduce the delay time for the door alarm to sound during on-peak time. Other power load reducing measures in a refrigerator may include (reducing before on-peak hours) the temperature of the freezer and refrigerator compartments in a refrigerator (prechill) and slightly increase temperature setting during on-peak rates. For example, just before peak rate time, the temperature setting could be decreased by 1-2 degrees (during off-peak rates). Some communication line with the electrical company could be established. Thus, the electrical company may be able to send a signal in advance to prechill the refrigerator (or in the case of an air conditioner, decrease the room temperature during off-peak rates as a pre-chill maneuver) and, in turn, increase the temperature setting during on-peak rates.

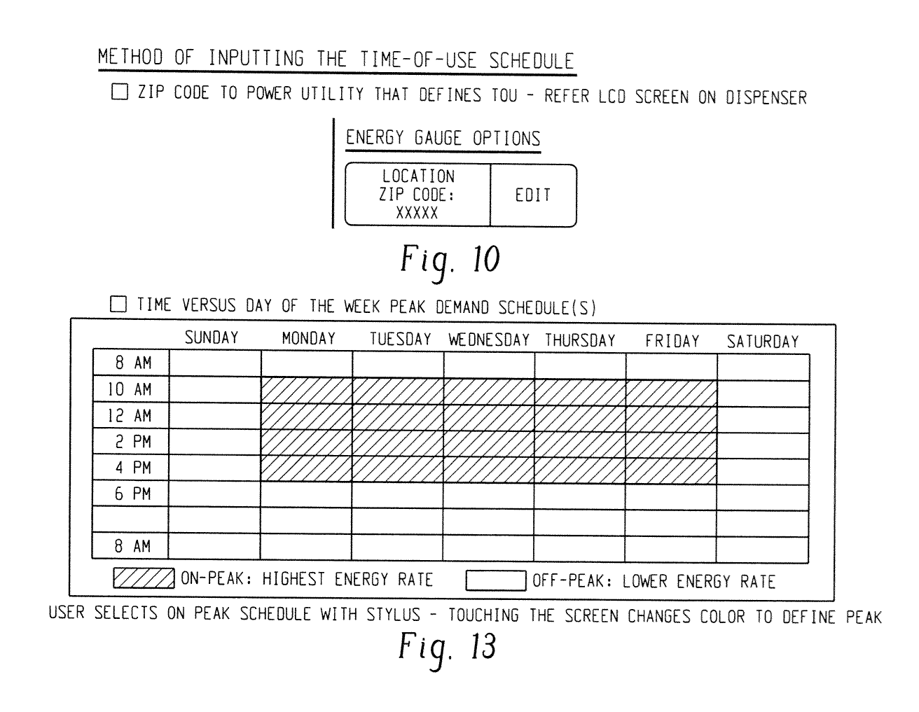

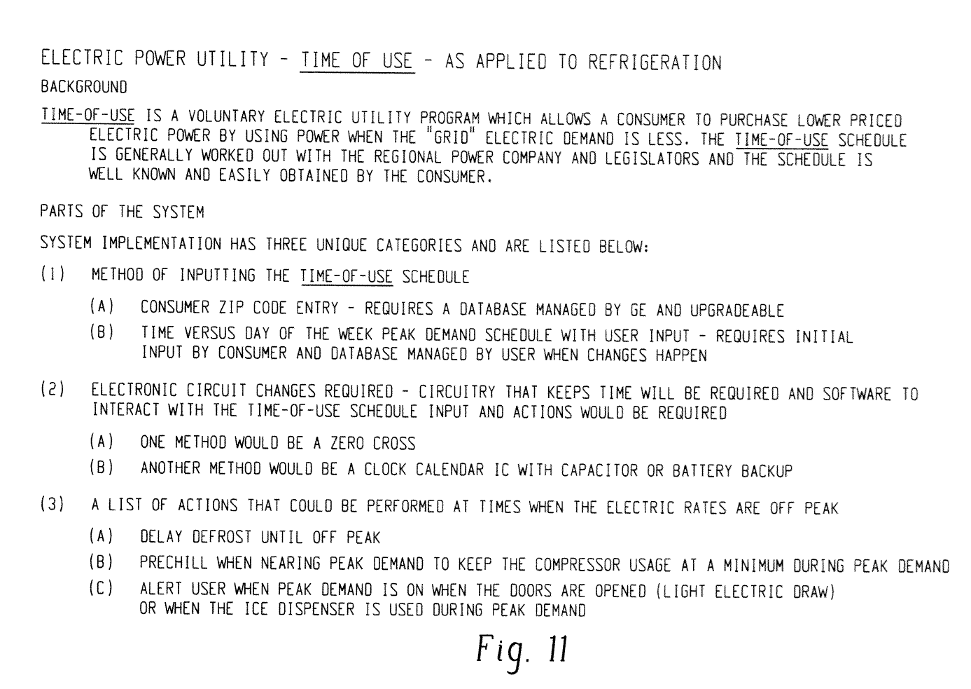

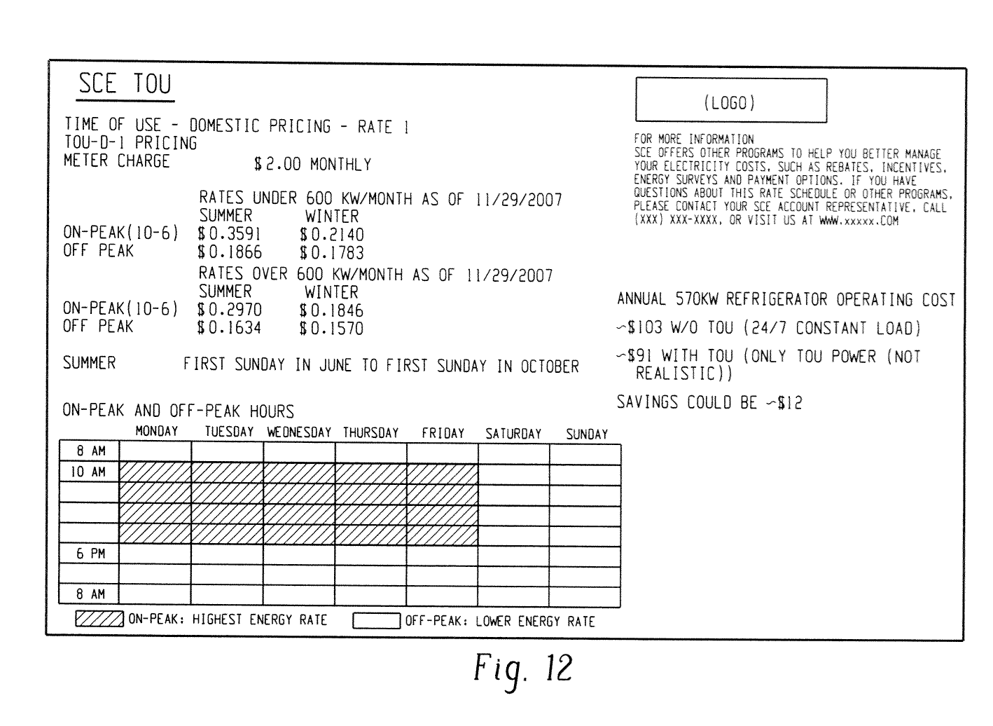

Still other energy consuming practices of the exemplary refrigerator that may be altered include turning the ice-maker off during on-peak demand times, or disabling the crushed ice mode during on-peak demand times. Alternatively, the consumer may be given the ability to select via a user interface which items are incorporated into the on-peak demand via an enable/disable menu, or to provide input selection such as entry of a zip code (FIG. 10) in order to select the utility company and time of use schedule (FIG. 11), or using a time versus day of the week schedule input method (FIGS. 12-13).

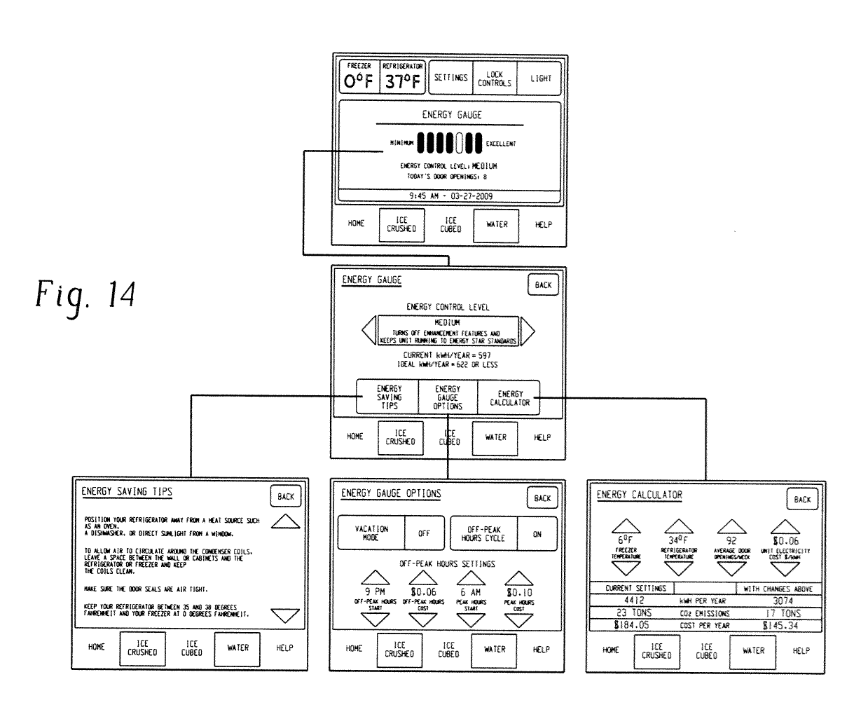

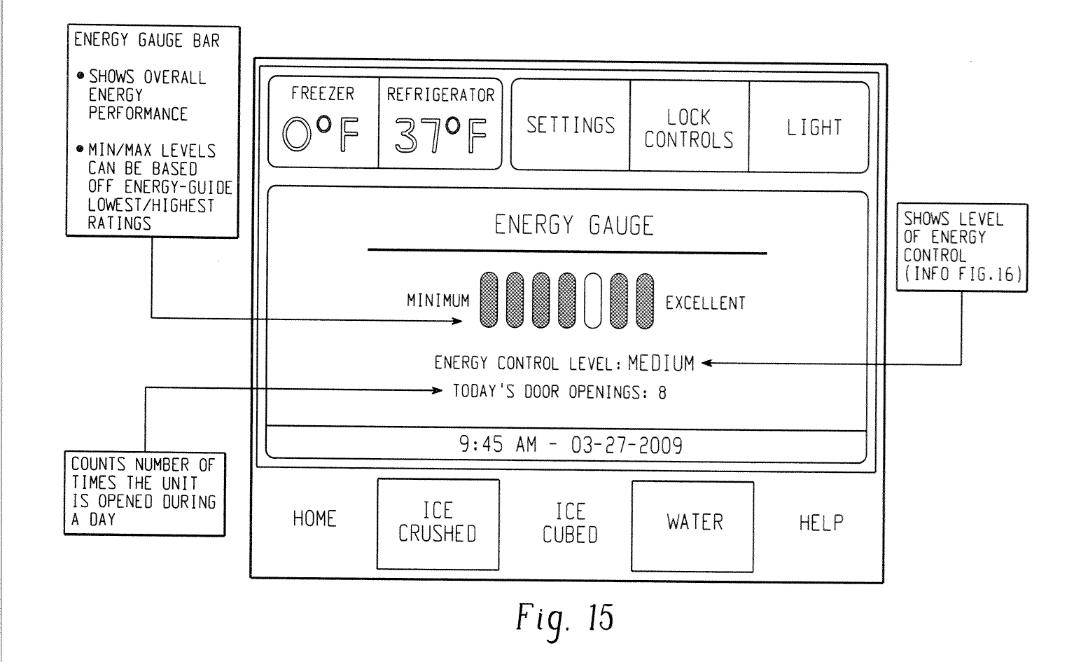

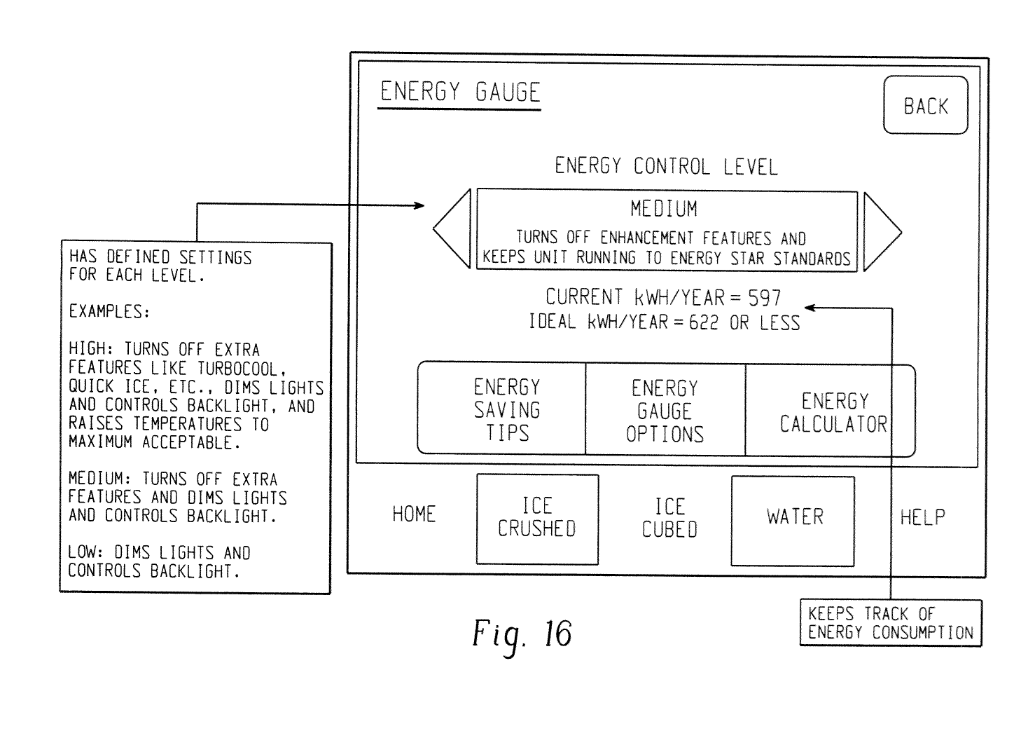

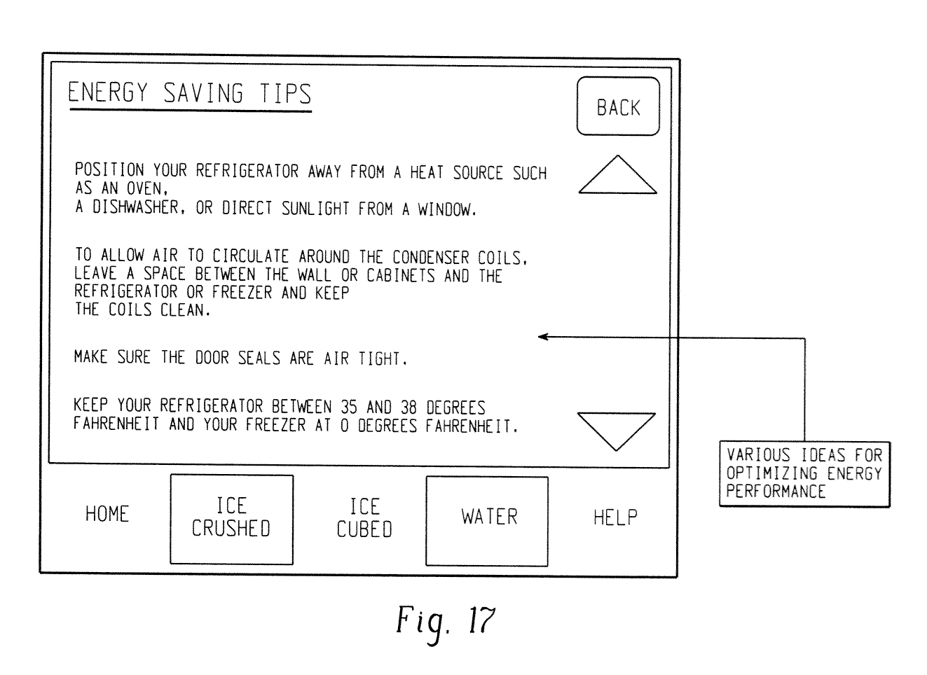

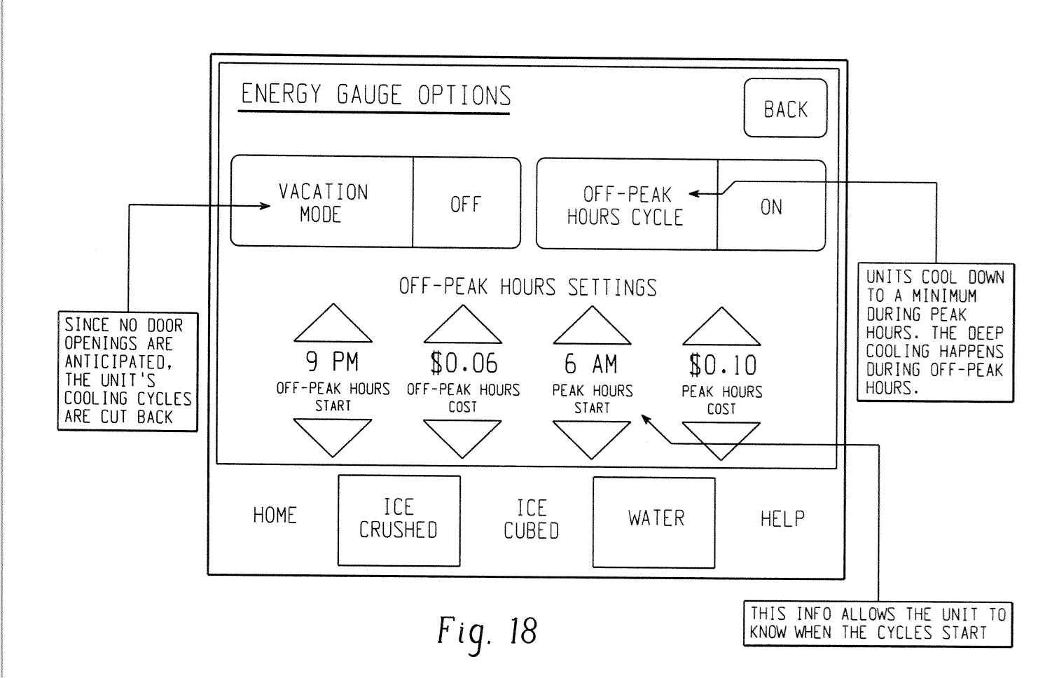

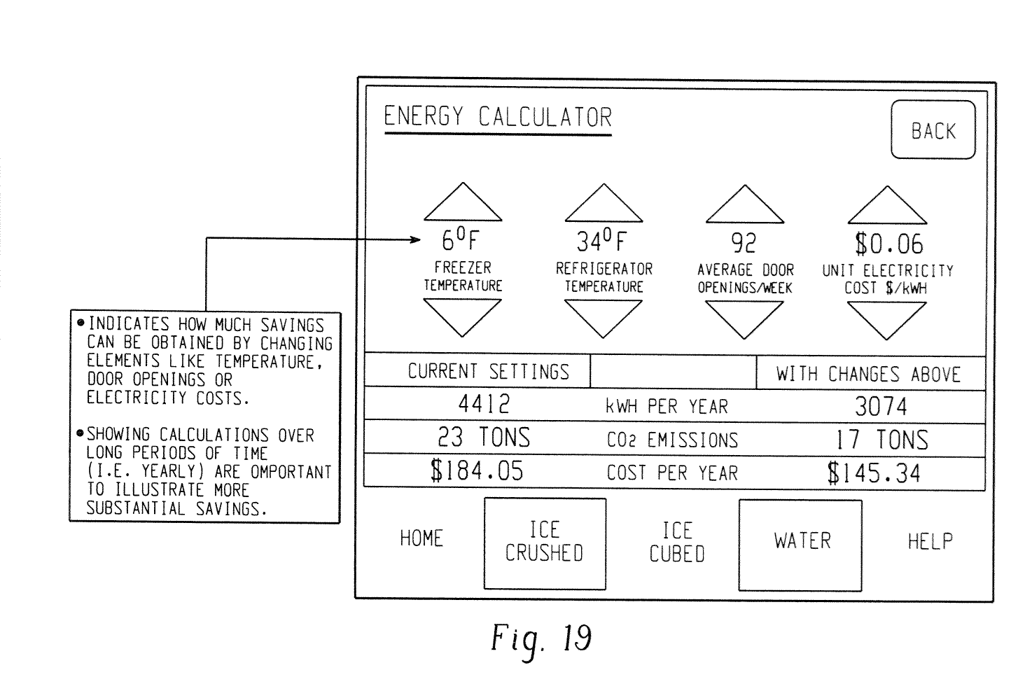

The user interface may also incorporate suggested energy saving tips or show energy usage, or provide an indicator during on-peak mode, or provide a counter to illustrate the energy impact of door opening, or showing an energy calculator to the consumer to serve as a reminder of the impact of certain selections/actions on energy use or energy conservation (FIGS. 14-19).

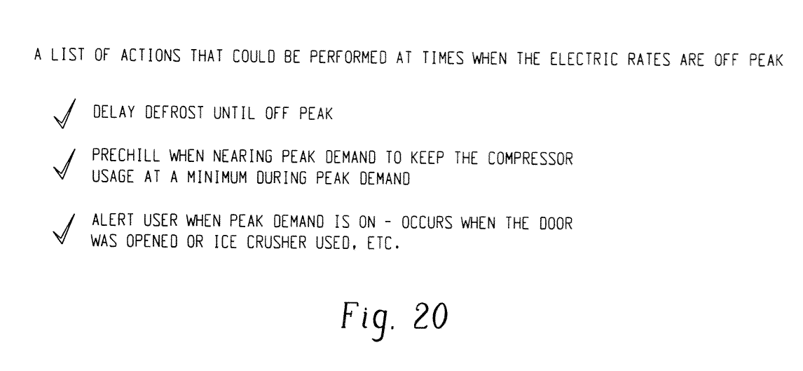

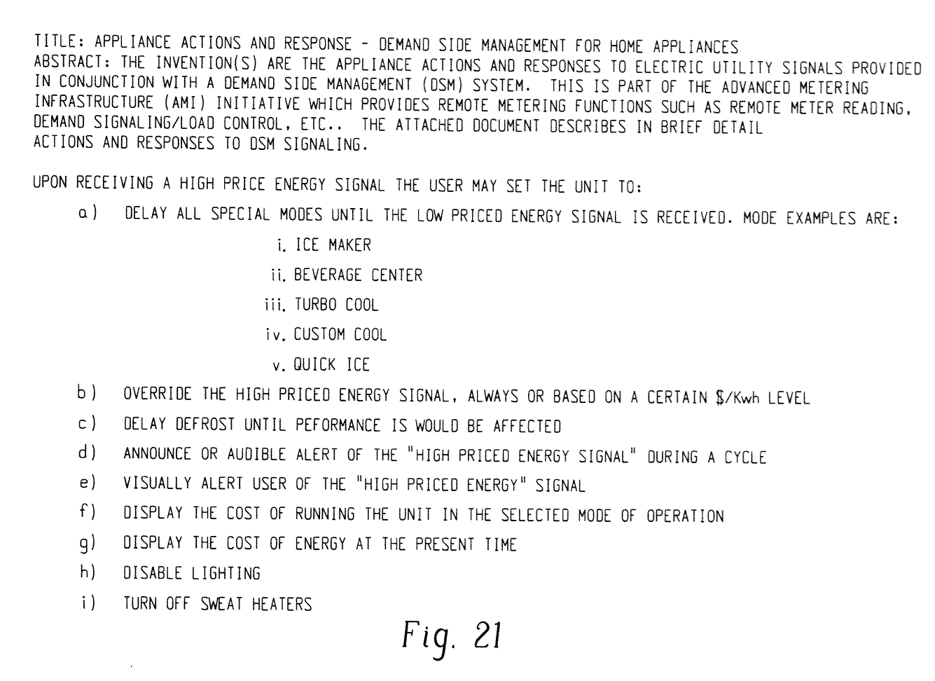

One path that is being pursued from the appliance perspective is to allow the onboard CPU (microprocessor) of the appliance to determine how to respond to an incoming signal asking for a load shedding response. For example, the CPU will turn on, turn off, throttle, delay, adjust, or modify specific functions and features in the appliance to provide a turndown in power consumption (FIG. 20). FIG. 21 defines specifically exemplary modes of what are possible. The main feature here is the enabling of the main board microprocessor or CPU to execute actions in the appliance to deliver load shedding (lowering power consumption at that instant). The actions available in each appliance are only limited to the devices that the CPU has control over, which are nearly all of the electrical consuming devices in an appliance. This may work better where the appliance has an electronic control versus an electromechanical control.

Of course, the above description focuses on the refrigerator but these concepts are equally applicable to other home appliances such as dishwashers, water heaters, washing machines, clothes dryers, televisions (activate a recording feature rather than turning on the television), etc., and the list is simply representative and not intended to be all encompassing.

Likewise, although these concepts have been described with respect to appliances, they may find application in areas other than appliances and other than electricity usage. For example, a controller that acts as an intermediary between the utilities meter and the appliance interprets the utility signal, processes it and then submits this signal to the appliance for the prescribed reaction. In a similar fashion, the controller may find application to other household utilities, for example, natural gas and water within the home. One can equip the water and gas meters to measure flow rates and then drive responses to a gas water heater or gas furnace precisely like the electrical case. This would assume that one might experience variable gas and water rates in the future. Secondly, the flow meters being connected to the controller could provide a consumer with a warning as to broken or leaking water lines by comparing the flow rate when a given appliance or appliances are on to the normal consumption. In cases where safety is a concern, the system could stop the flow of gas or water based on the data analysis.

Another feature might be the incorporation of “remote subscription” for the utility benefit. In some cases, the utility will be providing customers discounts/rebates for subscribing to DSM in their appliances, hot water heaters, etc. The “remote subscription” feature would allow the utility to send a signal that would “lockout” the consumer from disabling the feature since they were on the “rebate” program.

Another feature that the controller lends itself to is the inclusion of “Remote diagnostics”. This feature would allow the appliance to send a signal or message to the controller indicating that something in the appliance was not up to specifications. The controller could then relay this signal to the utility or to the appliance manufacturer via the various communication avenues included into the controller (i.e., WIFI, WIMAX, Broadband, cell phone, or any other formats that the controller could “speak”).

In the case of a remote subscription, the utilities today rely on the honesty of their subscribers to leave the DSM system functional. Some people may receive the discounts/rebate and then disable the feature that drives the load shedding. With this system, the utility can ensure that the feature will be enabled and provide the proper load shedding.

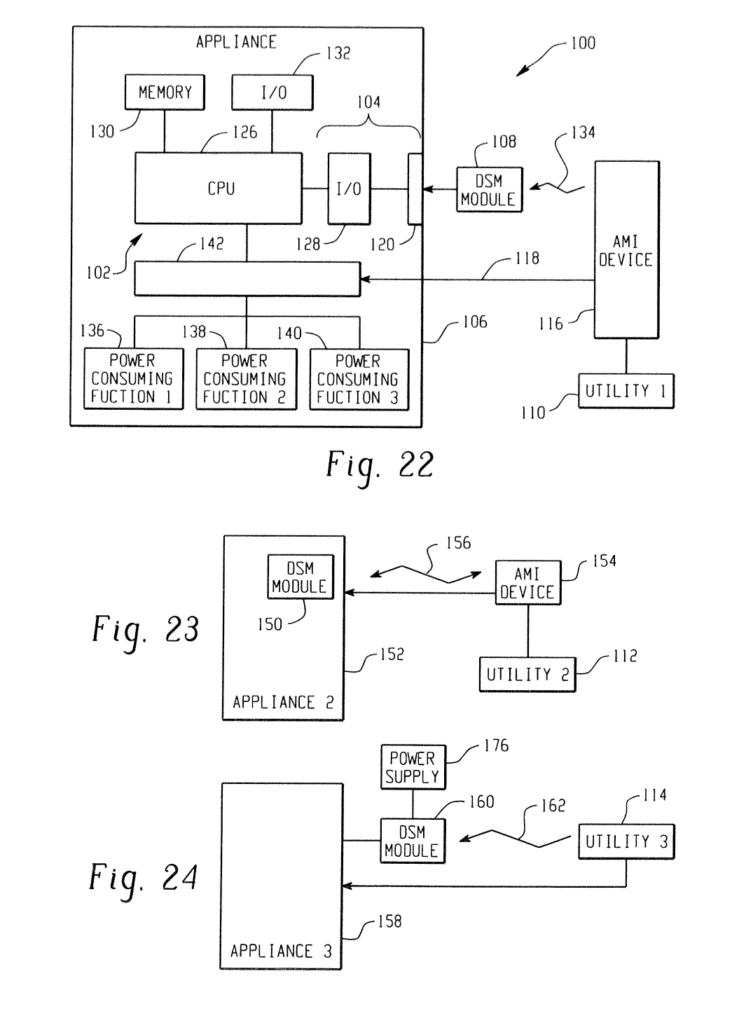

With reference to FIG. 22, a household appliance system is shown, and generally designated by reference numeral 100. The system 100 includes an appliance control system 102 having a common appliance interface 104 provided on an appliance 106. The appliance 106 can be, for example, a refrigerator, a dishwasher, an oven or range, a microwave, a washer, a dryer, or some other appliance. A demand side management (DSM) module 108 is connected (or connectable) to the common appliance interface 104. The module 108 can correspond to one select utility (e.g., a first utility 110) of a plurality of utilities, for example, electrical utility, gas utility, water utility, etc. (e.g., first utility 110, second utility 112 of FIG. 23 and third utility 114 of FIG. 24) and adapted to communicate with the one select utility of the plurality of utilities, e.g. selecting one of plural utilities based on zip code. As will be described in more detail below, the appliance control system 102 operates the appliance 106 based on communications with the one select utility 110 through the module 108.

While many configurations are possible, the embodiment illustrated in FIG. 22 shows the one select utility 110 including an advanced metering infrastructure (AMI) device 116 that communicates directly with the DSM module 108. For example, the AMI device 116 could be an electric meter that both communicates with the DSM module 108 and provides power to the appliance 106, such as via power supply line 118. While the power supply line 118 in FIG. 22 is shown as passing separately to the appliance 106 (i.e., not through the DSM module 108), it will be appreciated that other configurations could be employed, including having the power supply line 118 pass through the DSM module 108, for example. Also shown in the illustrated embodiment, the DSM module 108 can be received in a recessed receptacle 120 of the common appliance interface 104. For example, the module 108 can be removably connected to the common appliance interface 104 via the recessed receptacle 120, though other arrangements could be employed.

The appliance control system 102 can include a CPU 126 connected to the common appliance interface 104, particularly to an input/output interface 128 which itself is connected to the recessed receptacle 120, for communications with the module 108. The CPU 126 can also be connected to or include a memory 130 and, depending on the particular appliance, can include another input/output interface 132. The input/output interface 132 could include, for example, a display unit and/or an input unit. In one exemplary embodiment, the input/output interface 132 includes a display, which can be a touch screen display, and/or includes buttons for receiving user input, for example, a consumer can enter a zip code or other pertinent information or data into the control system. Based on communications 134 received from the AMI device 116 concerning the first utility 110, the control system 102, and particularly the CPU 126, can control power delivery, such as from power input line 118, to one or more power consuming functions, such as a first power consuming function 136, a second power consuming function 138, and a third power consuming function 140. In the illustrated embodiment, controlling of power from the power input line 118 to the power consuming functions 136, 138, 140 occurs through a power distribution module 142, which can be integrally provided with the CPU 126 or separately provided as shown in the illustrated embodiment.

The DSM module 108 can be one particularly selected due to its compatibility for communicating with the AMI device 116, for example receiving communications 134 from the AMI device 116. Communications 134 between the module 108 and the utility 110 through the AMI device 116 can be carried on via at least one of the following hardwired or wireless communication protocols: e.g., PLC, SM, AM SSB, WiFi, ZibBee, Radio Broadcast Data System, IEEE 802.11 standard compatible, or IEEE 802.15.4 standard compatible, or still other communication systems may be used without departing from the scope and intent of the present disclosure. Accordingly, if the utility 110 preferably communicates through the AMI device 116 by a particular wireless broadcast, the DSM module 108 can be one selected for receiving communications 134 of the same wireless broadcast type.

In an alternate configuration, and with reference to FIG. 23, the DSM module 150 is shown in an appliance 152 wherein the module 150 is an integral mounted module, which can be integrally mounted inside (i.e., internal to the appliance) and/or outside (i.e., external to the appliance) the appliance 152. Also shown in FIG. 23 is an alternate configuration wherein the module 150 communicates with AMI device 154 associated with the utility 112 through two-way communications 156. Such two-way communications can be any of those discussed above in connection with the module 108 suitable for two-way communications.

With reference to FIG. 24, still another alternate configuration is shown including an appliance 158 having a DSM module 160 that receives communications in association with a third utility 114. In this configuration, communications 162 to the module 160 can occur directly from the utility 114. For example, the utility 114 could broadcast over FM, AM SSB, or a radio broadcast data system, or over any other suitable communications protocol that allows direct communications from the utility 114 to the DSM module 160.

From the various arrangements depicted herein, it should be appreciated that the DSM module (e.g., modules 108, 150, 160) are all configured and selected such that they are capable of communicating with an AMI system, such as AMI system 164, schematically illustrated in FIG. 28. The module, such as module 166, can further be selected depending on the particular type of communications desired, for example, two-way communications 168 or one-way communications 170. Returning reference to FIG. 1, the appliance control system 102 can operate the appliance 106 in one of several states of operation based on the communications with the selected one utility 112 through the module 108. For example, the several states of operation can include a normal state and at least one of a low energy mode and a lower energy mode. By way of example, either of a low energy mode or the lower energy mode can include reducing or cutting power to at least one power consuming function, such as power consuming functions 136, 138, 140, of the appliance 106. Example power consuming functions are shown in FIG. 20 when the appliance 106 is a refrigerator. In one exemplary embodiment, the control system 102 can operate the appliance 106 in the low energy mode or the lower energy mode when the communications 134 with the select one utility 110 through the module 108 indicate that the select one utility 110 is providing power at a higher rate of at least two rates (e.g., peak power rate and a normal power rate) of a power rate cost schedule.

The module 108 can be powered from at least one of the appliance 106 or a separate power supply, for example in the embodiment illustrated in FIG. 22, the DSM module 108 can be powered by the appliance 106. In the embodiment illustrated in FIG. 24, the module 160 can be powered by a separate power supply 176, which could be a conventional 110 volt AC outlet, for example. In addition, or in the alternative, the separate power supply 176 could include rechargeable batteries that power the module 160. If desired, the module 108 for example, can be powered from the appliance, such as appliance 106, and is turned off by the appliance 106 until the appliance needs to make a decision about power usage related to the appliance. In one exemplary embodiment, the module 108 is powered from a separate power supply and the appliance control system 102 operates the appliance 106 in a low energy state, or a sleep mode, while the module 106 communicates with the one select utility 110.

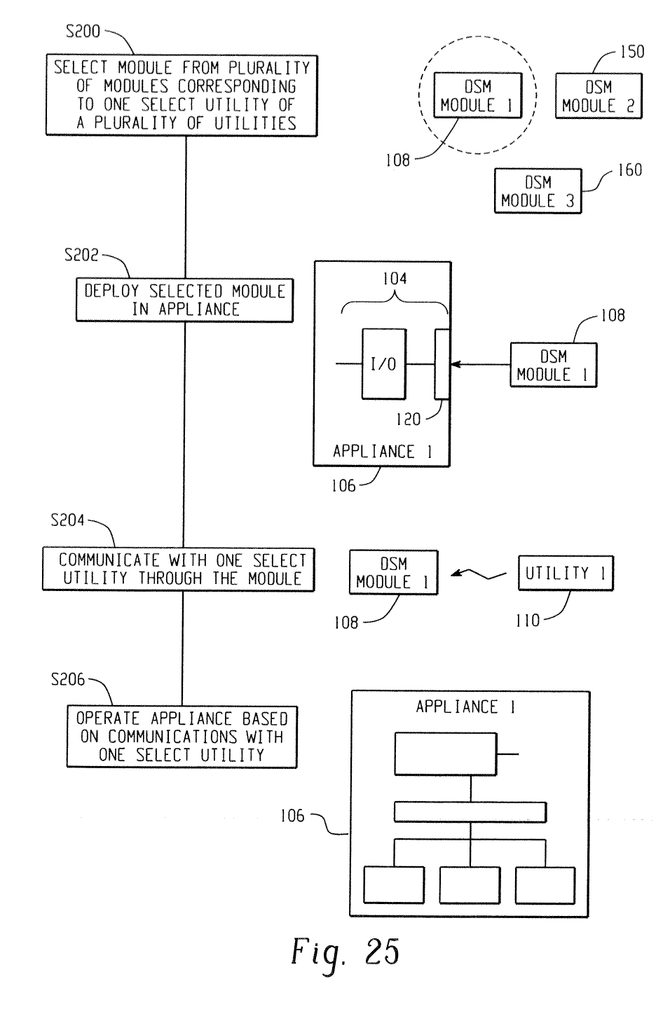

With reference to FIG. 25, a method for configuring an appliance to communicate with one select utility of a plurality of power utilities is illustrated (e.g., an electric utility, water utility, gas utility, etc., and second ones of an electric utility, water utility, or gas utility, etc). At S200, module 108 is selected from a plurality of modules, such as modules 108, 150, 160 and/or other modules (not shown). In S202 the selected module 108 is deployed in an appliance, such as appliance 106. For example, deploying the selected module 108 in the appliance 106 can include installing the module 108 in recess receptacle 120, such as removably installing the module 108 in the recess receptacle 120 through the common appliance interface 104. Once deployed, the appliance 106 can communicate with the one select utility 110 (e.g., a particular one of perhaps multiple electrical or other types of utilities) through the module 108 as indicated in S204. Thereafter, the appliance 106 can be operated as already described herein based on the communications with the select one utility 110 as indicated at S206.

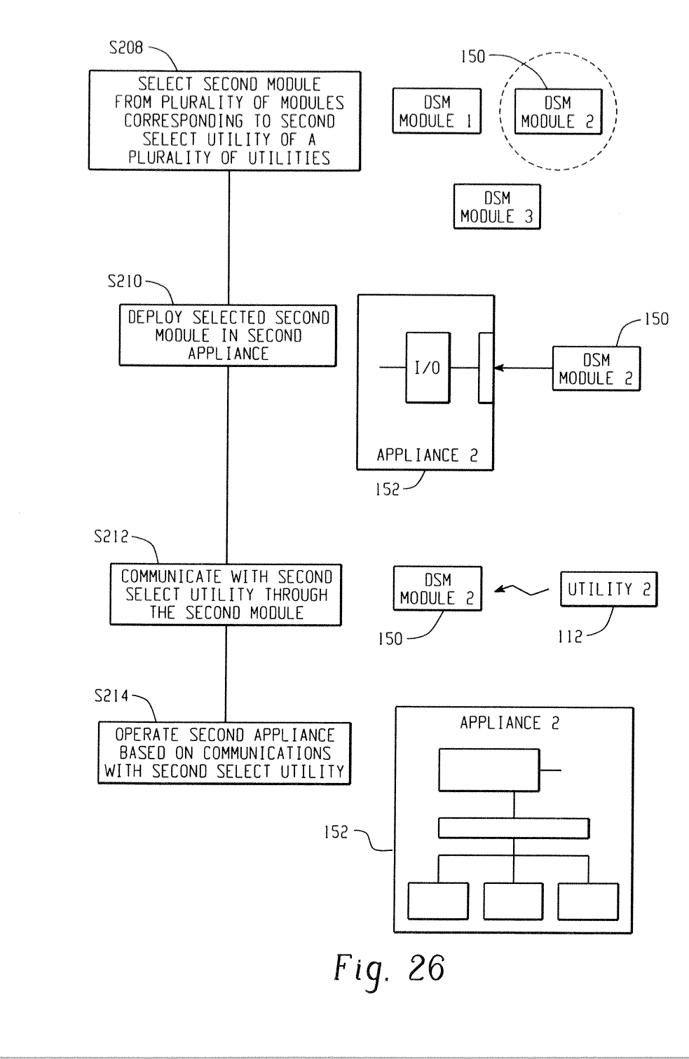

Turning to FIG. 26, a second module, such as module 150, can be selected from the plurality of modules, such as modules 108, 150, 160 and/or other modules (not shown), the second module 150 corresponding to a second select utility (a different one of perhaps multiple electrical or other types of utilities), such as utility 112, of a plurality of utilities as indicated at S208. The selected second module 150 can be deployed in a second appliance, such as appliance 152 in the same manner as described reference to the module 108 being deployed in the appliance 106 as indicated at S210. Once deployed, the appliance 152 can communicate with the second select utility 112 through the second module 150 as indicated at S212. Next, the second appliance 152 can be operated based on the communications with the second select utility 112 as indicated at S214.

As described above, communications with the utilities, such as at S204 and S212, can occur through the respective modules 108, 150 using an accepted communication protocols, which may include: PLC, FM, AM SSB, WiFi, ZibBee, Radio Broadcast Data System, IEEE 802.11 standard compatible, or IEEE 802.15.4 standard compatible. Operating the appliance based on the communications, such as at S206 and S214, can include operating the appliance in at least one of a low energy mode and a lower energy mode. For example, operating the appliance based on communications with one of the utilities 110, 112 can include reducing or cutting power to at least one power consuming function of the appliance.

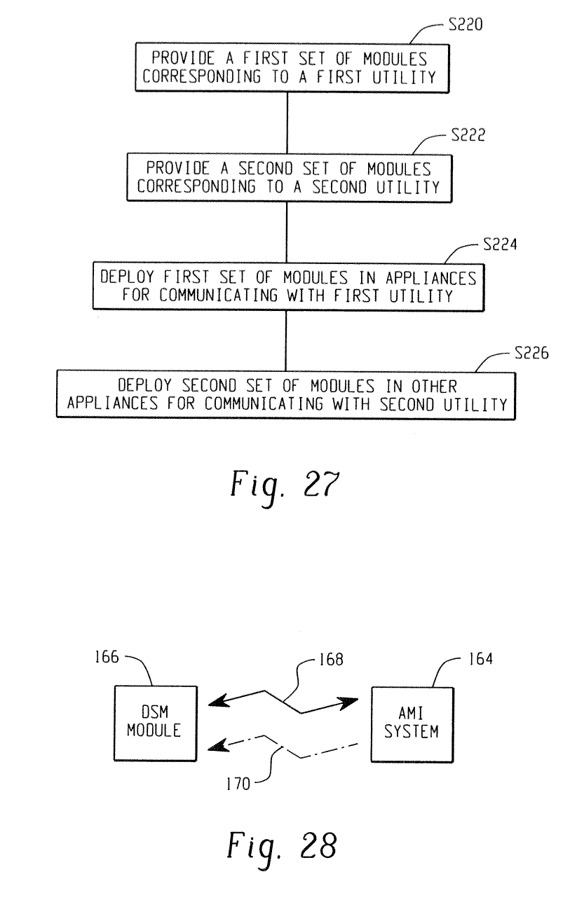

Turning to FIG. 27, a method for configuring appliance to communicate with power utilities is shown. In particular, at S220 a first set of modules corresponding to a first utility (e.g., a first electric utility) is provided. At S222, a second set of modules corresponding to a second utility (e.g., a second electric utility) is provided. The first set of modules can correspond to the first utility, particularly in that they are pre-adapted to communicate with the first utility. Likewise, the second set of modules can be such that they are pre-adapted to communicate with the second utility. As described in S202 and S210, the first set of modules from S220 can be deployed in a first set of appliances for communicating with a first utility (S224). Similarly, a second set of modules can be deployed in a second set of appliances for communicating with a second utility (S226). Once deployed, the first set of appliances can communicate with the first set of modules using a first communication protocol and the second set of appliances can communicate with the second utility through the second set of modules using a second, different communication protocol.

As will now be appreciated, connecting each appliance or other device to the home energy management device (e.g., controller, etc) is central to the system's ability to manage the devices. While each appliance in the previously described examples is connected individually via a DSM module, it will be appreciated that cost savings can be realized by having a plurality of appliances connect via a common communication interface.

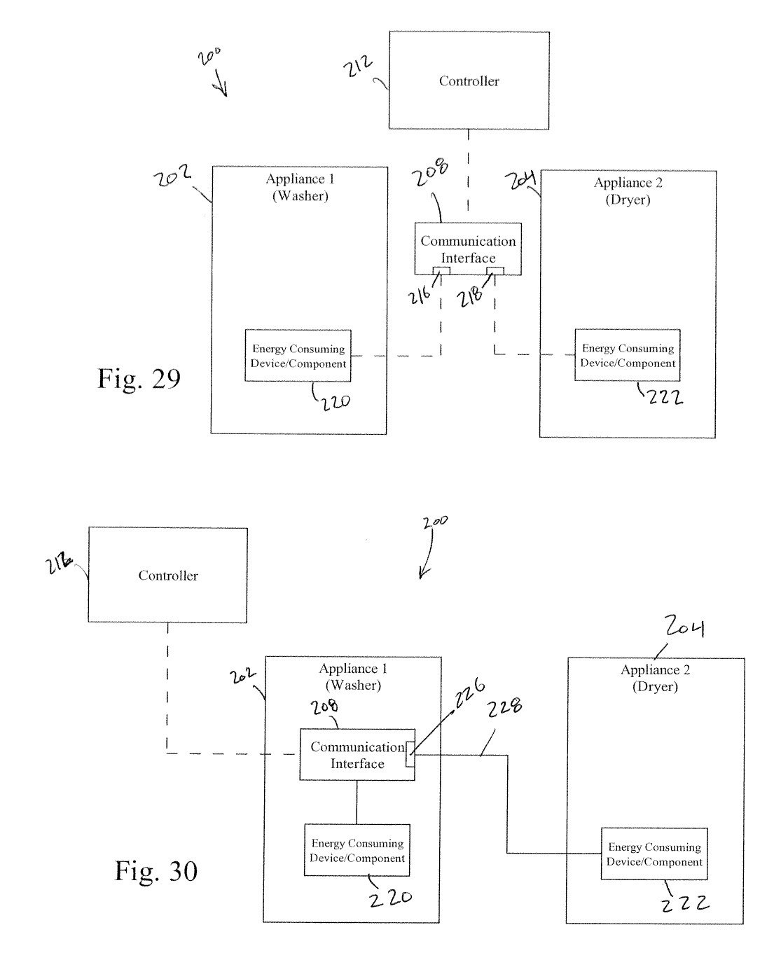

Now referring to FIG. 29, a system 200 is illustrated including a pair of appliances 202 and 204 sharing a common communication interface 208 for communicating with, for example, a controller 212 of an energy management network. The appliances 202 and 204 in this example are a washer and dryer set. Typically such appliances are located in close proximity to each other and, thus, are well-suited to sharing a communication interface. Other appliances that may be well-suited to sharing a connection to the controller are kitchen appliances (e.g., cooking appliances), and HVAC/water heater equipment. Of course, any relatively closely situated appliances or devices could also share a connection via a common communication interface. As will be appreciated, the communication interface 208 can be used to connect the appliance 202 and 204 to any other device or appliance such as, for example, the devices modules etc. described previously.

In FIG. 29, the communication interface 208 is a separate module that can be attached to two or more appliances. For example, the communication interface 208 includes first and second ports 216 and 218 for communicating with respective energy consuming components 220 and 222 of the appliances 202 and 204. Each appliance may include a plurality of energy consuming components, each component configured to communicate with the communication interface 208. For example, a washer may include one or more pumps and one or more motors. A dryer may include a heating element and a motor. In the case of a refrigerator, energy consuming components can include a compressor, a defrost heater, ice maker, and lights. Each energy consuming load of an appliance can be connected to the communication interface directly or, more likely, through an appliance control panel or the like.

As will be appreciated, the communication interface 208 can be connected wirelessly to each appliance 202 and 204. Suitable wireless protocols for such connections can include Bluetooth, Wifi, RFID, Zigbee radio, and 802.15.4 radio. More likely, the communication interface 208 will be wired to one or both of the appliances 202 and 204 using a suitable protocol such as an Ethernet or serial connection, for example. For example, the communication module 208 can be a Y-connector cable having first and second ends for connecting to the appliances 202 and 204, and a third end connected to the communication interface 208.

In either case, the communication interface 208 can be configured to determine what appliances it is connected to, and then further configured to communicate with a processor or other device within the energy management system to thereby control an aspect of operation of the appliances. In this regard, the communication interface 208 can be configured to communicate commands to the energy consuming devices for the control thereof. Further, information relating to energy usage of the appliances and/or energy consuming components can be communicated to the controller for use by the controller in controlling at least one aspect of operation of an appliance or energy consuming component.

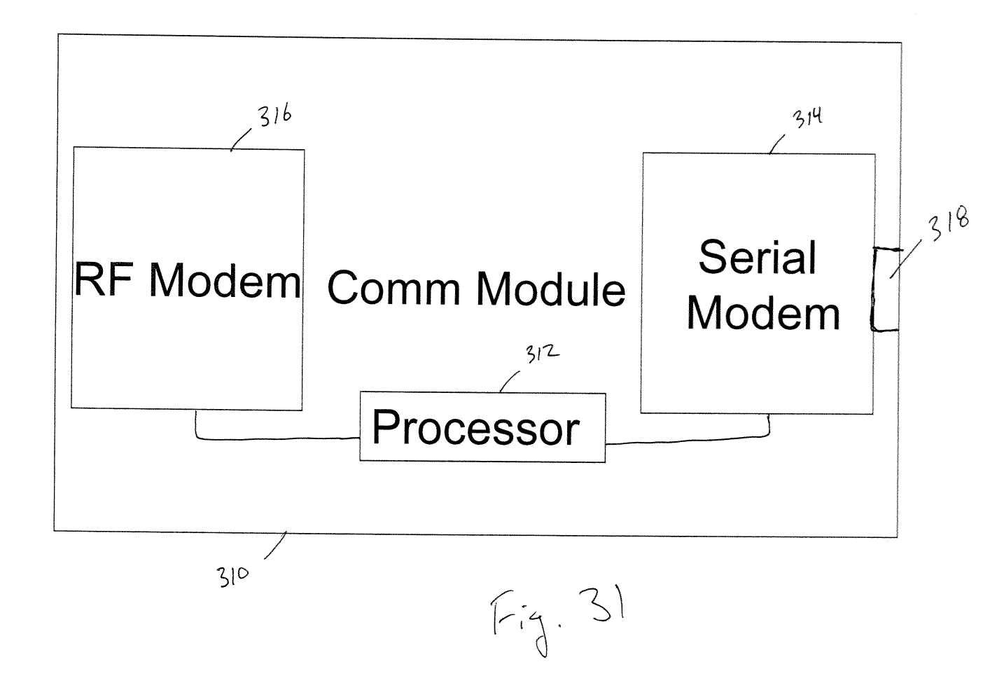

Turning now to FIG. 30, the washer 202 contains the communication interface 208, and the dryer 204 is connected to a port 226 of the communication interface 208 via a wired connection 228. In many instances where the appliances or devices are very close, a wired connection via Ethernet or serial cable or the like can be the most economical manner of connecting the two appliances together. Otherwise, suitable wireless communication protocols can be used, such as Wifi, Bluetooth, etc. In either case, sharing a single communication interface 208 helps to keep down the cost of the washer/dryer combo. Moreover, the operation of the two appliances 202 and 204 can be more easily coordinated since information about each appliance can be utilized by the other appliance. For appliances such as a washer and a dryer that are commonly operated together, this can provide for further customization and management functionality.

In FIG. 31, an exemplary communication module (interface) 310 is illustrated. The communication module 310 can be associated with one or more appliances in the same manner as the communication interface 208 of FIGS. 29 and 30. The communication module 310 includes a processor 312, a serial modem 314 and an RF modem 316. The serial modem 314 can be configured to communicate with one or more appliances via a port 318 and a wired connection, and otherwise functions in a similar manner to communication port 226 previously described. The RF modem 316 can be configured to communicate with one or more appliances, as well as a controller, such as controller 212 described in connection with FIGS. 29 and 30. As will be appreciated, more than one RF modem 316 and/or serial modem 314 can be provided in the module 310.

In operation, the RF module can be configured to receive communications information from the controller (which can be part of a smart meter) in a format designed for communication over the air. Preferably, the format is based on a recognized standard. The processor 312 may then strip the message packet out of the over the air message. The processor 312 may optionally determine whether the message is intended for all appliances or a specific appliance. The message is then formatted by the processor into a format appropriate for a wired link for sending to one or more appliances. The serial modem 314 then sends the reformatted message to the microprocessor of one or more associated appliances via the port 318. As will be appreciated, each appliance may have a corresponding serial port, for example, embedded in a processor of an associated communication module or on the appliance itself. In some applications, a single serial port of the module may be suitable for communicating with multiple appliances.

The invention has been described with reference to the preferred embodiments. Obviously, modifications and alterations will occur to others upon reading and understanding the preceding detailed description. For example, it is understood that a first utility can be one of many different types of utilities and likewise a second utility can be one of many different types of utilities, as well as referring to the situation where the first and second utilities are the same type of utility (e.g., both electric) but different companies or suppliers. It is intended that the invention be construed as including all such modifications and alterations.

What is claimed is:

1. An appliance comprising:
an energy consuming device; and
a communication interface for sending/receiving communications between the appliance and a remote energy management device, the communications including at least one of commands for controlling the energy consuming device and data relating to the usage of the energy consuming device;
wherein the communication interface further includes a communication port for communicating with a second appliance, the communication interface adapted to relay communications between the second appliance and the remote energy management device.

2. An appliance as set forth in claim 1, wherein the communication port is a wired port adapted to receive a cable from the at least one other appliance for communication therewith.

3. An appliance as set forth in claim 2, wherein the wired port includes at least one of an Ethernet port, a serial port, RS-232 serial port, I2C, RS-485, and Firewire.

4. An appliance as set forth in claim 1, wherein the communication port is a wireless port adapted to communicate wirelessly with the at least one other appliance.

5. An appliance as set forth in claim 4, wherein the wireless port is adapted to communicate with the at least one other appliance via at least one short-range wireless communication protocol including Bluetooth, Wifi, RFID, Zigbee radio, and 802.15.4 radio.

6. An appliance as set forth in claim 1, wherein the appliance and the at least one other appliance are a pair of appliances commonly associated with each other and in close proximity including a washer/dryer set, a microwave oven and a cooking range, an HVAC unit and a water heater.

7. An appliance as set forth in claim 1, wherein the appliance is configured to utilize data received from the at least one other appliance for controlling at least one aspect of its operation.

8. A device for connecting a plurality of energy consuming devices to a home energy management network comprising:
a first communication port for communicating with a first energy consuming device;
a second communication port for communicating with a second energy consuming device; and
a communication interface for communicating with a remote device, the communication interface adapted to connect the first and second communication ports to the remote device for communication therewith.

9. A device as set forth in claim 8, wherein the communications include at least one of commands for controlling the energy consuming devices and data relating to the usage of the energy consuming devices.

10. A device as set forth in claim 8, wherein at least one of the first and second communication ports is a wireless communication port.

11. A device as set forth in claim 9, wherein the wireless communication port is adapted to communicate via at least one short-range wireless communication protocol including Bluetooth, Wifi, RFID, Zigbee radio, and 802.15.4 radio.

12. A device as set forth in claim 8, wherein the communication interface is a wireless communication interface.

13. A device as set forth in claim 8 in the form of a Y-connector cable having first and second ends for connecting to the first and second energy consuming devices, and a third end connected to the communication interface including an RF radio, wherein the communication interfaces is adapted to communicate with the first and second energy consuming devices when connected thereto via the Y-connector.

14. An appliance including the device as set forth in claim 8, wherein the appliance is the first energy consuming device and the first communication port communicates with the appliance, and wherein the second communication port is adapted to communicate with a second appliance.

15. A system of appliances for use in a home energy management network comprising a first appliance having an energy consuming device, a second appliance having an energy consuming device, and the device as set forth in claim 8 connected to the first and second appliances via its first and second communication ports.

16. A system as set forth in claim 15, wherein the device for connecting a plurality of energy consuming devices to a home energy management unit is integrated with one of the first or second appliances.

17. A system of appliances as set forth in claim 15, wherein the first and second appliances are a pair of appliances commonly associated with each other and in close proximity including a washer/dryer set, a microwave oven and a cooking range, an HVAC unit and a water heater.

18. A system of appliances as set forth in claim 15, wherein the first appliance is configured to utilize data received from the second appliance for controlling at least one aspect of its operation.

19. A method of connecting a plurality of energy consuming devices to a home energy management network comprising:
connecting a first energy consuming device to a second energy consuming device;
communicating data relating to the usage of the second energy consuming device to the first energy consuming device; and
communicating data via a communication interface of the first energy consuming device relating to the usage of both the first and second energy consuming devices;
wherein the first energy consuming device is associated with a first appliance and the second energy consuming device is associated with a second appliance.

20. A method as set forth in claim 19, further comprising controlling at least one aspect of operation of the first energy consuming device in response to data received from the second energy consuming device.
